(19) United States
(12) Patent Application Publication
(10) Pub. No.: US 2026/0167765 A1
(43) Pub. Date: Jun. 18, 2026

(54) FULLY RECYCLABLE, DUAL DYNAMIC BOND-BASED, HIGH-STRENGTH EPOXY POLYMER AND METHOD FOR PRODUCING THE SAME

(71) Applicant: PUSAN NATIONAL UNIVERSITY INDUSTRY-UNIVERSITY COOPERATION FOUNDATION, Busan (KR)

(72) Inventors: Chae Bin KIM, Busan (KR); Suk-kyun AHN, Busan (KR); Jae Hyeok LEE, Busan (KR); Gyeong Hwan CHOI, Busan (KR); Yeomyung YOON, Busan (KR)

(73) Assignee: PUSAN NATIONAL UNIVERSITY INDUSTRY-UNIVERSITY COOPERATION FOUNDATION, Busan (KR)

(21) Appl. No.: 19/393,007

(22) Filed: Nov. 18, 2025

(30) Foreign Application Priority Data
Dec. 18, 2024 (KR) 10-2024-0190117

(51) Int. Cl. C08G 59/24; C08G 59/42; C08G 59/68

(52) U.S. Cl. CPC C08G 59/245; C08G 59/423; C08G 59/686

(57) ABSTRACT

A fully recyclable high-strength epoxy polymer includes a first monomer containing two or more epoxy groups, a second monomer comprising a sulfur-containing aliphatic carboxylic acid, and a third monomer acting as a catalyst. The epoxy polymer is synthesized through dual dynamic reactions using the third monomer that facilitates a reaction between the epoxy groups of the first monomer and both ends of the aliphatic carboxylic acid of the second monomer.

### CROSS-REFERENCE TO PRIOR APPLICATION

This Application claims priority to Korean Patent Application No. 10-2024-0190117 (filed on Dec. 18, 2024), which is hereby incorporated by reference in its entirety.

### BACKGROUND

The present disclosure relates to a fully recyclable, dual dynamic bond-based, high-strength epoxy polymer and a method for producing the same, and more particularly, to a fully recyclable, dual dynamic bond-based, high-strength epoxy polymer, which exhibits performance that can replace conventional epoxy materials and, at the same time, may contribute to the minimization of environmental pollution by being recyclable multiple times and is characterized by having high strength, reprocessability, and high heat resistance, and a method for producing the same.

Epoxy materials are thermosetting polymers with cross-linked molecular chains, so they have high mechanical strength, high chemical resistance, excellent thermal stability, and high specific strength, making them indispensable materials in the electrical and electronic, automobile, ship, and aerospace industries, and their applications are limitless. However, thermosetting epoxy materials have a problem in that once cross-linked, they cannot be processed any further, and thus are difficult to recycle and should be disposed of.

Epoxy material is made up of an epoxy resin and a curing agent and is easy to process in a liquid state. Based on this processability, it is made into a composite resin through processes such as impregnation of fillers such as carbon fiber, and has a very wide range of uses. Since the epoxy monomer has low viscosity before curing, it requires less energy to mix with fillers, and since the epoxy monomer forms a cross-linked structure after curing, it exhibits high mechanical strength, chemical resistance, and thermal stability.

In addition, among various types of commercial epoxy resins and curing agents for application under various conditions, aromatic ring-containing bisphenol A-based epoxy resin and Jeffamine that may exhibit high mechanical strength are most commonly used for carbon fiber-reinforced plastics (CFRPs) that are composite materials. However, in the case of epoxy resin, once cross-linked, it can no longer be processed, and thus is difficult to recycle. Therefore, in recent years, due to environmental issues caused by waste polymers, the need for development of materials that are recyclable while having good properties has increased.

Meanwhile, to solve the problems described above, research on covalent adaptable networks (CANs), which are polymers crosslinked by dynamic bonds, has been actively conducted. CANs are polymers in which the polymer chains are crosslinked by dynamic bonds rather than the permanent covalent bonds of conventional thermosetting resins. Dynamic bond exchange reactions are accelerated by external stimuli such as heat and light. Since the exchange reactions do not occur before the external stimuli are applied, the overall topology remains fixed as if frozen. Thus, for most CANs, the dynamic bond exchange reactions are accelerated by heat.

For example, at temperatures above the topology freezing transition temperature (Tᵥ), which is the temperature at which the exchange reactions start to become active, dynamic exchange reactions are actively initiated, the molecular topology can be rearranged, and reprocessing is possible. On the other hand, at temperatures below Tᵥ, the polymer behaves like a typical thermosetting polymer.

When the covalent adaptable network (CAN) is introduced, it may be used as an excellent material having high mechanical strength, chemical resistance, and heat resistance, which is a cross-linked polymer whose topology remains frozen at the actual use temperature, and when reprocessing/recycling is required, heat can be applied to rearrange the topology and recycle the polymer. Thus, the covalent adaptable network (CAN) may have the advantages of both thermoplastic and thermosetting polymers.

However, among CANs, materials having high physical properties based on high crosslinking density and polymer structures such as aromatic rings have low chain mobility, and thus require harsh reprocessing conditions such as high temperature, high pressure, and long time. Reprocessing for a long time at high temperatures causes thermal decomposition and oxidation of polymer chains, which significantly reduces the performance of the material, such as causing deterioration of mechanical strength, discoloration, and lowering of weather resistance, thereby diminishing the meaning of reprocessing.

As such, even when CANs are recycled multiple times, harsh conditions inevitably reduce the number of recycling times so that CANs are recyclable only once or twice, thereby diminishing the meaning of recyclable thermosetting polymers. In addition, if introduced dynamic bonds with one reactivity are vulnerable to high temperature, acid, moisture, UV, etc., there is a concern that the long-term usability may be greatly reduced due to the decomposition of the functional group and the deterioration of the structural stability of the sample.

Therefore, the inventors of the present disclosure have made efforts to overcome the above-described problems, and as a result, have developed a high-strength epoxy polymer which has characteristics of high strength, reprocessability, and high heat resistance, and at the same time, may contribute to the minimization of environmental pollution by being recyclable multiple times, thereby completing the present disclosure.

### RELATED ART

Korean Patent Application Publication No. 10-2021-0071285 (published on Jun. 16, 2021)
Korean Patent Application Publication No. 10-2024-0068227 (published on May 17, 2024)

### SUMMARY

The present disclosure has been made in order to solve the above-described problems, and an object of the present disclosure is to provide a fully recyclable, dual dynamic bond-based, high-strength epoxy polymer, which exhibits performance that can replace conventional epoxy materials and, at the same time, may contribute to the minimization of environmental pollution by being recyclable multiple times and is characterized by having high strength, reprocessability, and high heat resistance, and a method for producing the same.

A preferred embodiment of the present disclosure for achieving the above object provides a fully recyclable high-strength epoxy polymer comprising: a first monomer containing two or more epoxy groups; a second monomer comprising a sulfur-containing aliphatic carboxylic acid; and a third monomer acting as a catalyst, the epoxy polymer being synthesized through dual dynamic reactions using the third monomer that facilitates the reaction between the epoxy groups of the first monomer and both ends of the aliphatic carboxylic acid of the second monomer.

The dual dynamic reactions may include transesterification and disulfide metathesis reactions.

The first monomer may comprise any one or more selected from the group consisting of bisphenol-based epoxy resin, aminophenol-based epoxy resin, siloxane-based epoxy resin, and alicyclic epoxy resin.

The second monomer may be any one selected from the group consisting of 2.2′-dithiobenzoic acid, 3.3′-dithiopropionic acid, 4,4′-dithiodibutyric acid, 5,5′-dithiobis(2-nitrobenzoic acid), 6,6′-dithiodinicotinic acid, DL-homocystine, penicillamine disulfide, and L-glutathione oxidized.

The third monomer is preferably 1,5,7-triazabicyclo[4.4.0]dec-5-ene (TBD).

The epoxy polymer preferably comprises the first monomer (DGEBA) and the third monomer (TBD) at a molar ratio of 1 to 2.5:0.02 to 0.04 moles per mole of the second monomer (DTDA).

The epoxy polymer is decomposable and recyclable when immersed and heated in an aqueous solution of 1,5,7-triazabicyclo[4.4.0]dec-5-ene (TBD).

The epoxy polymer may have a shape memory property that allows it to return to its original shape at a temperature above the glass transition temperature (T_{g}) thereof.

Another preferred embodiment of the present disclosure for achieving the above-described object provides a method for producing a fully recyclable high-strength epoxy polymer, comprising: a step of preparing a transparent solution by mixing and heating a first monomer and a second monomer; a step of preparing a mixture by adding a third monomer to the transparent solution, followed by stirring; a step of pre-curing the mixture by heating after pouring the mixture into a mold; and a main curing step of curing the pre-cured mixture by heating in a vacuum.

The first monomer may comprise any one or more selected from the group consisting of bisphenol-based epoxy resin, aminophenol-based epoxy resin, siloxane-based epoxy resin and alicyclic epoxy resin.

The second monomer may be any one selected from the group consisting of 2.2′-dithiobenzoic acid, 3.3′-dithiopropionic acid, 4,4′-dithiodibutyric acid, 5,5′-dithiobis(2-nitrobenzoic acid), 6,6′-dithiodinicotinic acid, DL-homocystine, penicillamine disulfide, and L-glutathione oxidized.

The third monomer is preferably 1,5,7-triazabicyclo[4.4.0]dec-5-ene (TBD).

Preferably, the step of preparing the transparent solution comprises mixing the first monomer (DGEBA) and the second monomer (DTDA) at a molar ratio of 1 to 2.5:1, and the step of preparing the mixture comprises adding the third monomer (TBD) in an amount of 0.02 to 0.04 moles per mole of the second monomer (DTDA).

Preferably, the step of preparing the transparent solution comprises heating to a temperature of 170 to 190° C., the step of pre-curing comprises curing by heating at a temperature of 170 to 190° C. for 45 to 75 minutes, and the main curing step comprises curing by heating at a temperature of 170 to 190° C. for 3 to 10 hours at a vacuum pump pressure of 0 to 0.1 MPa.

The dual dynamic bond-based high-strength epoxy polymer according to the present disclosure is a material that may replace conventional epoxy materials, which have the disadvantage of being difficult to recycle because they can no longer be reprocessed once crosslinked due to the nature of epoxy materials. The epoxy polymer according to the present disclosure has excellent characteristics of high strength, reprocessability, and high heat resistance, and thus exhibits performance that can replace conventional epoxy materials, and at the same time, may contribute to the minimization of environmental pollution by being recyclable multiple times.

Therefore, the inventors of the present disclosure have made efforts to overcome the above-described problems and developed a high-strength epoxy polymer which has characteristics of high strength, reprocessability, and high heat resistance, and at the same time, may contribute to the minimization of environmental pollution by being recyclable multiple times, thereby completing the present disclosure.

### BRIEF DESCRIPTION OF THE DRAWINGS

FIG. 1 is a diagram showing the results of performing ATR-FTIR analysis depending on the DGEBA contents of epoxy-covalent adaptable networks (E-CANs) according to a preferred embodiment of the present disclosure.

FIG. 2 shows the results of measuring the gel content of E-CAN depending on the curing time (2-hour interval).

FIG. 3 shows the results of measuring the curing temperature range in the first heating cycle of E-CAN after 4 hours of curing.

FIG. 4 shows the results of measuring the glass transition temperature (T_{g}) in the second heating cycle of E-CAN after 4 hours of curing.

FIG. 5 shows the results of measuring the tensile strengths of E-CANs and the strength of conventional epoxy for CFRPs.

FIG. 6 shows the results of measuring the tensile strengths of E-CANs after third recycling and the strength of conventional epoxy for CFRPs.

FIG. 7 is a photograph showing the state of E-CANs after reprocessing under certain temperature/pressure conditions.

FIG. 8 shows the results of T_{d5%} TGA measurement of E-CANs (R1, R1.5, R2, R2.3, and R2.5) depending on the concentration of DGEBA.

FIG. 9 shows the results of measuring the storage moduli of E-CANs through temperature sweep tests.

FIG. 10 shows the loss factors of E-CANs shown through temperature sweep tests.

FIG. 11 shows the results of fitting E-CANs to the WLF equation and the Arrhenius equation using the stress relaxation time measured as a function of temperature.

FIG. 12 is photographs showing the original E-CAN-R2.3 and its state after 24 hours on a hot plate at 160° C. in various solvents.

FIG. 13 shows the results of measuring the FT-IR peaks of pristine E-CAN-R2.3 and degraded E-CAN-R2.3.

FIG. 14 shows the results of measuring the weight percentage of chemical decomposition in H₂O/TBD at 160° C. for 12 hours.

FIG. 15 is photographs showing the process of recycling E-CAN-R2.3 without an additional purification process.

FIG. 16 shows the results of measuring FT-IR peaks depending on the weight percentage of E-CAN-R2.3 recycled without an additional purification process after chemical decomposition in H₂O/TBD at 160° C. for 12 hours.

FIG. 17 is photographs showing the process of E-CAN shape memory at a temperature above the glass transition temperature (T_{g}).

FIG. 18 is photographs showing the process in which the E-CAN is fixed in the shape of a pinwheel through stress relaxation above the topology freezing transition temperature (Tᵥ) and then returns to the shape of a pinwheel.

### DETAILED DESCRIPTION

Preferred embodiments of the present disclosure will be described in detail below with reference to the accompanying drawings. However, detailed description of configurations and functions that are readily apparent to those skilled in the art will be omitted. In addition, it should be noted that the present disclosure is not necessarily limited to the following embodiments, and that various modifications may be made to the present disclosure without departing from the technical spirit of the present disclosure.

The terms used in the present specification are currently widely used general terms selected in consideration of their functions in the present disclosure, but they may change depending on the intents of those skilled in the art, precedents, or the advents of new technology. Additionally, in certain cases, there may be terms arbitrarily selected by the applicant, and in this case, their meanings are described in a corresponding description part of the present disclosure. Accordingly, terms used in the present disclosure should be defined based on the meaning of the term and the entire contents of the present disclosure, rather than the simple term name.

Hereinafter, a fully recyclable, dual dynamic bond-based, high-strength epoxy polymer according to a preferred embodiment of the present disclosure will be described in detail.

A dual dynamic bond-based high-strength epoxy polymer according to the present disclosure comprises: a first monomer containing two or more epoxy groups; a second monomer comprising a sulfur-containing aliphatic carboxylic acid; and a third monomer acting as a catalyst, and is simply synthesized through dual dynamic reactions (DDRs) using the third monomer that facilitates the reaction between the epoxy groups of the first monomer and both ends of the aliphatic carboxylic acid of the second monomer.

The dual dynamic bond-based high-strength epoxy polymer is synthesized by forming a covalent adaptable network (CAN) through dual dynamic reactions (DDRs) between the first monomer and the second monomer, i.e., transesterification and disulfide metathesis reactions, as shown in Reaction Scheme 1 below.

In the specification of the present disclosure, the “dual dynamic bond-based high-strength epoxy polymer” is named “epoxy-CAN” or “E-CAN” because it is synthesized by synthesized by forming a dynamic bonding network (CAN) as described above.

The first monomer may comprise any one or more selected from the group consisting of bisphenol-based epoxy resin, aminophenol-based epoxy resin, siloxane-based epoxy resin, and alicyclic epoxy resin.

Specifically, the first monomer is preferably bisphenol A diglycidyl ether (DGEBA).

The second monomer may be any one selected from the group consisting of 2.2′-dithiobenzoic acid, 3.3′-dithiopropionic acid, 4,4′-dithiodibutyric acid, 5,5′-dithiobis(2-nitrobenzoic acid), 6,6′-dithiodinicotinic acid, DL-homocystine, penicillamine disulfide, and L-glutathione oxidized.

Specifically, the second monomer is preferably 4,4′-dithiodibutyric acid (DTDA).

Only both ends of dithiodibutyric acid (DTDA) used in the present disclosure may form ester-hydroxyl groups that enable transesterification, and also have disulfide bonds, and thus only the equivalent ratio of DTDA may control the ratio of the transesterification reaction group. Based on this, by controlling the ratio of bisphenol A-based epoxy resin while fixing the equivalent ratio of DTDA, the dynamic crosslinking and permanent crosslinking density may be controlled.

In addition, since the crosslinking density may also controlled by etherification of hydroxyl groups and homopolymerization through ring opening of the epoxy itself, the mechanical strength, heat resistance, and recyclability of the material may be controlled as desired.

The third monomer is preferably 1,5,7-triazabicyclo[4.4.0]dec-5-ene (TBD).

The epoxy-CAN preferably comprises the first monomer (DGEBA) and the third monomer (TBD) at a molar ratio of 1 to 2.5:0.02 to 0.04 moles per mole of the second monomer (DTDA).

The epoxy-CAN is completely decomposed when 1,5,7-triazabicyclo[4.4.0]dec-5-ene (TBD) is immersed in a mixed solution of water and TBD and then reacted at 140 to 180° C. for 12 to 24 hours. When the water in the decomposed epoxy-CAN is evaporated, the epoxy-CAN may be reused as a raw material.

As the mixed solution of water and TBD, an aqueous solution in which 0.69 to 1.39 g of TBD is dissolved in 10 ml of water is preferably used.

In the present disclosure, the mixing ratio between the first monomer, the second monomer, and the third monomer is preferably within the above limited range. If the mixing ratio is out of the above limited range, there is a concern that inefficient synthesis may be performed due to the remaining unreacted monomers.

In addition, the epoxy-CAN may have a shape memory property that allows it to return to its original shape at a temperature above the glass transition temperature (T_{g}) thereof.

The epoxy-CAN according to the present disclosure has a molecular weight between crosslinks (Mc) of 2,000 to 25,000.

The epoxy-CAN synthesis reaction according to the present disclosure specifically involves dual dynamic reactions as shown in Reaction Scheme 1 below, wherein the reactions may include transesterification and disulfide metathesis reactions.

Therefore, according to the present disclosure, an epoxy-CAN having both two dynamic bonds resulting from transesterification and disulfide metathesis is synthesized so that a plurality of exchange reaction groups are included within the molecular space. Therefore, the topology freezing temperature (Tᵥ) is reduced compared to that of a polymer having a single type dynamic bond, and thus reprocessing of the epoxy-CAN is possible under relaxed conditions.

In addition, according to the present disclosure, a relatively simple synthesis and promotion of the exchange reactions are possible by using only one type of catalyst, 1,5,7-triazabicyclo[4.4.0]dec-5-ene (TBD), which effectively acts in both exchange reactions. Thus, the present disclosure is suitable for replacing high-strength epoxy materials that require harsh reprocessing conditions. This allows the epoxy material with high mechanical strength to be reprocessed multiple times while having a high reprocessing property recovery rate.

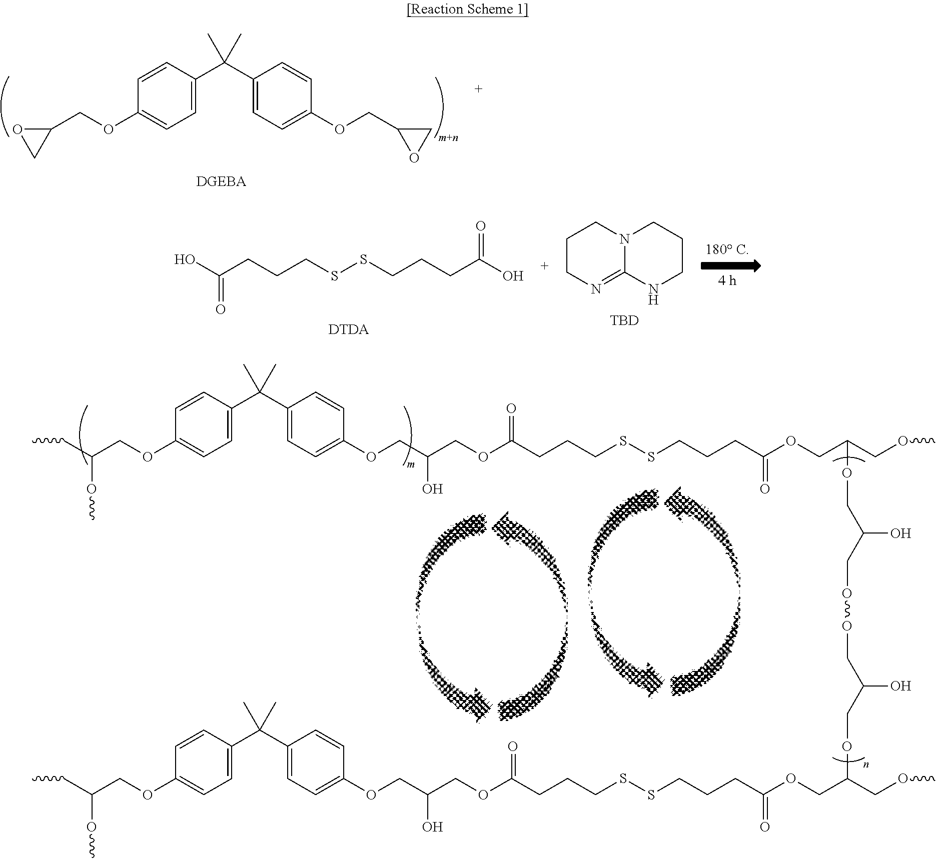

The epoxy-CAN synthesis reaction involves dual dynamic reactions, and the reactions shown in Reaction Schemes 2.1 to 2.4 below occur.

According to Reaction Scheme 2.1 below, the epoxy rings of DGEBA and the carboxylic acid DTDA react to generate ester groups and hydroxyl groups, thereby forming a molecular structure capable of transesterification.

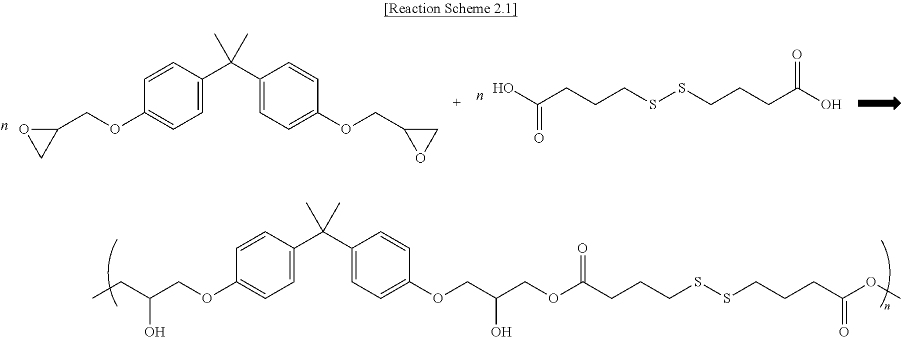

In addition, due to the disulfide bond within DTDA, a dual dynamic network with two exchange reaction networks is formed. As shown in Reaction Scheme 2.2 below, an epoxy ring at the end of an excess epoxy group is attached to the remaining hydroxyl group, causing etherification, and a permanent cross-linked structure that does not undergo an exchange reaction without a dynamic bond is formed.

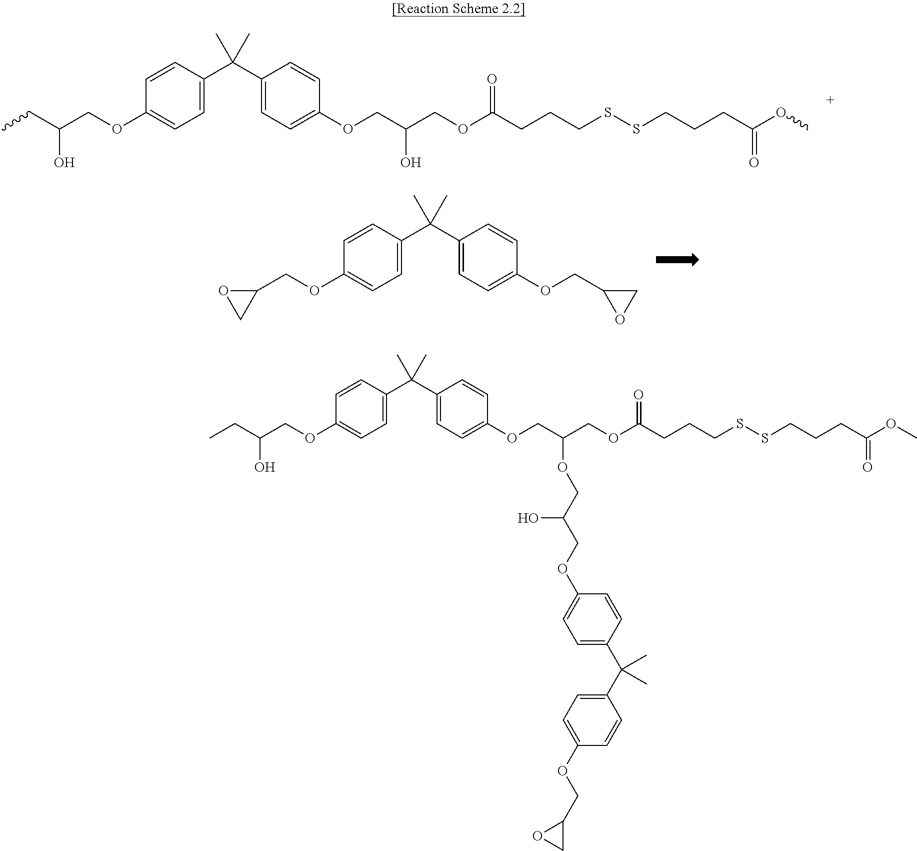

Reaction Schemes 2.3 and 2.4 below show additional reactions that can occur. As shown in Reaction Scheme 2.3 below, condensation esterification occurs, and as shown in Reaction Scheme 2.4 below, an ether bond is formed through homopolymerization of the epoxy itself, thereby forming a permanent cross-linked structure. In other words, it can be predicted that, as the content of DGEBA increases, not only the crosslinking density increase, but also the proportion of permanent crosslinking among dynamic crosslinking/permanent crosslinking further increases.

TBD acts as a catalyst that facilitates the reaction between the epoxy rings and both ends of the carboxylic acid. TBD also acts as a catalyst for two exchange reactions within the generated epoxy-CAN: transesterification and sulfide metathesis.

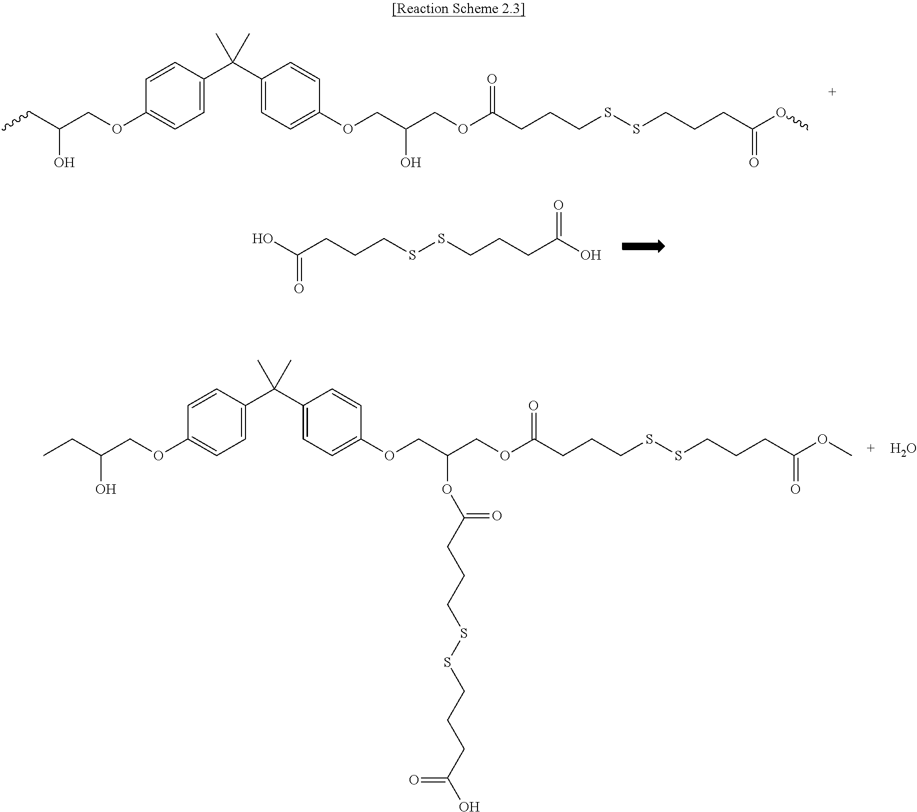

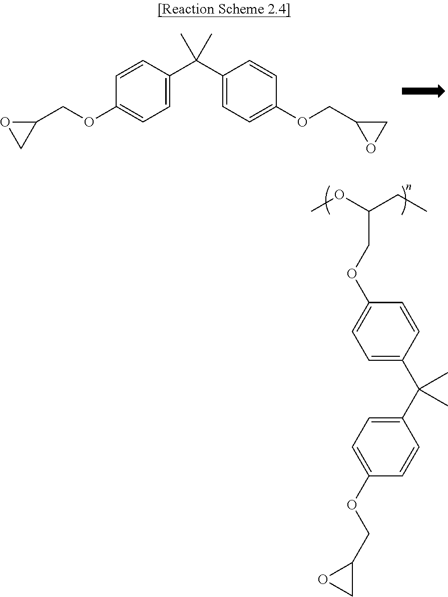

Meanwhile, another preferred embodiment of the present disclosure provides a method for producing a fully recyclable, dual dynamic bond-based, high-strength epoxy polymer (epoxy-CAN).

The method for producing epoxy-CAN may comprise: a step of preparing a transparent solution by mixing and heating a first monomer and a second monomer; a step of preparing a mixture by adding a third monomer to the transparent solution, followed by stirring; a step of pre-curing the mixture by heating after pouring the mixture into a mold; and a main curing step of curing the pre-cured mixture by heating in a vacuum.

Since the first monomer, the second monomer, and the third monomer have been described in detail above, description thereof will be omitted here.

Preferably, the step of preparing the transparent solution comprises mixing the first monomer (DGEBA) and the second monomer (DTDA) at a molar ratio of 1 to 2.5:1, and the step of preparing the mixture comprises adding the third monomer (TBD) in an amount of 0.02 to 0.04 moles per mole of the second monomer (DTDA).

Preferably, the step of preparing the transparent solution comprises heating to a temperature of 170 to 190° C., the step of pre-curing comprises curing by heating at a temperature of 170 to 190° C. for 45 to 75 minutes, and the main curing step comprises curing by heating at a temperature of 170 to 190° C. for 3 to 10 hours at a vacuum pump pressure of 0 to 0.1 MPa.

For reference, when the mixing ratio and process conditions of the compounds limited above in the description of the method for producing a high-strength epoxy polymer according to the present disclosure are within the above limited ranges, an epoxy polymer having optimal physical properties may be produced, but the process conditions are not necessarily limited to the process conditions described above and may be appropriately adjusted.

Hereinafter, the present disclosure will be described in detail through examples to aid understanding of the present disclosure. However, the following examples are merely illustrative of the contents of the present disclosure and the scope of the present disclosure is not limited to the following examples. The examples of the present disclosure are provided to more fully explain the present disclosure to those of ordinary skill in the art.

### 1. Synthesis of Epoxy-Covalent Adaptable Network (E-CANs)

Dual dynamic bond-based high-strength epoxy polymers (E-CANs) were synthesized as described below by using 4,4′-dithiodibutyric acid (DTDA) at a fixed molar ratio of 1 mole, 1,5,7-triazabicyclo[4.4.0]dec-5-ene (TBD) at a fixed molar ratio of 0.03 moles, and bisphenol A diglycidyl ether (DGEBA) at molar ratios of 1, 1.5, 2, 2.3, and 2.5 moles.

First, DGEBA was stirred at 200 rpm on a hot plate at 180° C., and then DTDA was added thereto. The mixture was stirred until it became a transparent liquid. Next, TBD was added to the transparent liquid, followed by stirring for 5 minutes. Then, the resulting solution was poured onto a Teflon sheet and pre-cured for 1 hour in a hot press at 180° C. Then, the pre-cured sample was placed in a vacuum oven with a vacuum pump pressure of 0 to 0.1 MPa and cured for 3 hours, thereby producing an E-CAN sample.

The E-CAN synthesis was carried out using DGEBA at molar ratios of 1, 1.5, 2, 2.3, and 2.5. Thus, the synthesized E-CANs were named “E-CAN-R #” according to the ratio (#) of DGEBA to DTDA. Specifically, the synthesized E-CANs were referred to as E-CAN-R1, E-CAN-R1.5, E-CAN-R2, E-CAN-R2.3, and E-CAN-R2.5, respectively.

### 2. Characterization of E-CANs

### <Experimental Example 1> Confirmation of Synthesis of E-CANs

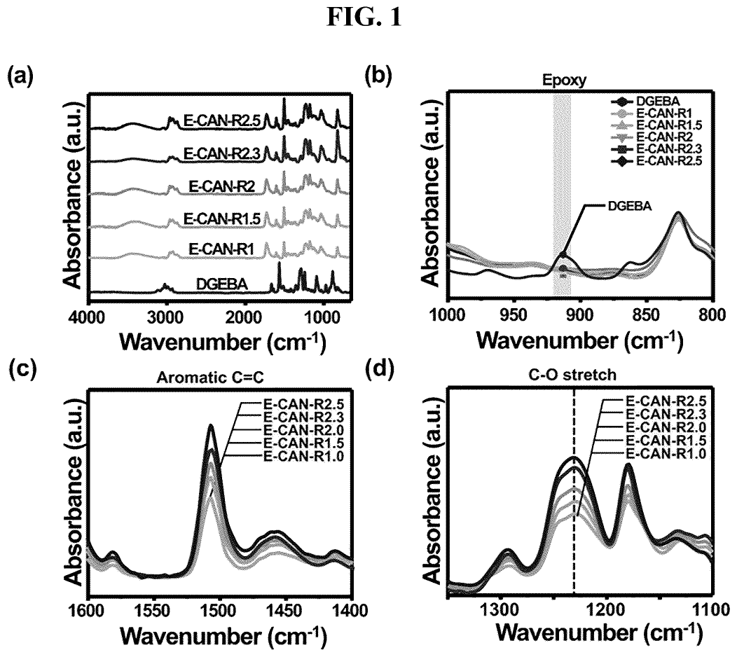

In order to confirm that there was no problem with the ratio of the monomers used in the above synthesis and that there was no residual monomer, and to confirm that the desired chemical structure was formed, attenuated total reflection-Fourier transform infrared (ATR-FTIR) analysis was performed at a resolution of 8 cm⁻¹ with 32 scans under the conditions of 4000-650 cm⁻¹, and 1720 cm⁻¹ COOR, and the results are shown in FIG. 1.

For reference, FIG. 1(a) shows the total FT-IR of E-CAN-R # depending on the DGEBA ratio and the DGEBA monomer, FIG. 1(b) shows the change in the epoxy peak (910 cm⁻¹) between before and after synthesis, FIG. 1(c) shows the increase in the aromatic C═C bond peak depending on the DGEBA content of E-CAN-R #, and FIG. 1(d) shows the increase in the aromatic ether bond peak depending on the DGEBA content of E-CAN-R #.

When comparing before and after curing, it was confirmed that the epoxy peak in the ATR-FTIR spectrum disappeared as shown in FIG. 1(b), suggesting that complete curing was achieved without any residual monomer.

In addition, as shown in FIG. 1(c), it could be seen that, as the content of the benzene ring in the 1,580 cm⁻¹ wavelength region gradually increased, the correct normalization was obtained, and at the same time, a stiffer material was created.

As shown in FIG. 1(d), it could be predicted through the increase in the ester peak in the 1,230 cm⁻¹ wavelength region that etherification of the hydroxyl groups and the epoxy rings and homopolymerization of the epoxy itself occurred, resulting in a higher crosslinking density and an increase in the proportion of permanent crosslinking.

### <Experimental Example 2> Confirmation of Optimal Curing Conditions

To confirm whether cross-linking between polymer chains was properly formed, an experiment for gel content measurement was conducted. To determine the mass change of a sample cured at different times at 160° C., the gel content was measured by swelling the sample in tetrahydrofuran for 24 hours, followed by drying in a vacuum oven for 24 hours. The solvent dissolves DGEBA and DTDA, but does not dissolve E-CAN.

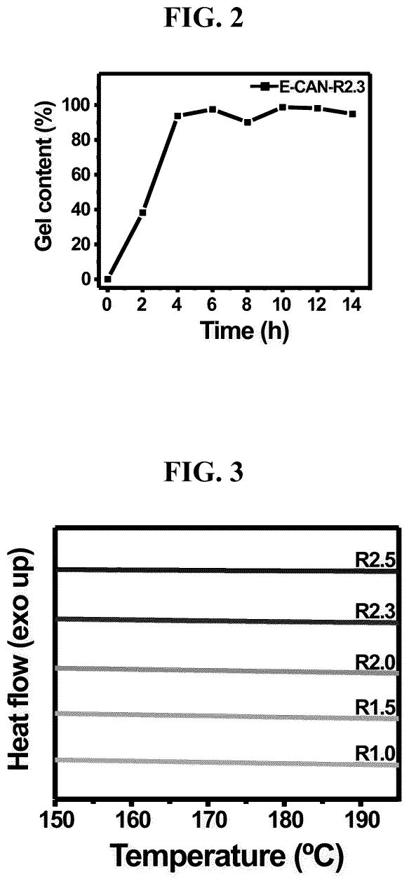

Referring to FIG. 2, the gel content leveled off at 90% or more when measured every 2 hours starting from 4 hours, and thus 4 hours was selected as the optimal curing condition. The curing condition for all samples measured thereafter was set to 4 hours.

### <Experimental Example 3> Determination of Glass Transition Temperature (T_{g})

In differential scanning calorimetry (DSC) analysis, samples that have not been fully cured exhibit an exothermic peak near the curing temperature because a crosslinked structure is formed and regularity increases. Using DSC, E-CAN-R # samples were heated from 25° C. to 200° C. in a nitrogen atmosphere, cooled to −80° C., and then heated back to 200° C., and the first heating cycle near the curing temperature was checked. As a result, as shown in FIG. 3, it was confirmed that no peak appeared near the curing temperature (180° C.), suggesting once again that the samples were completely cured.

In addition, the glass transition temperature (T_{g}) of the polymers was determined by DSC analysis of E-CAN-R #, and the T_{g} was determined in the second heating cycle to eliminate the effect of cold crystallization.

T_{g} is, by definition, the temperature at which segmental motion of a polymer begins. At temperatures above T_{g}, the free volume increases, and the molecular motion of the polymer chains becomes significantly more active, thus increasing the thermal capacity.

Therefore, T_{g} could be determined by observing the inflection point of the line occurring in the endo up direction in the DSC graph. T_{g} was defined based on the center of the inflection point.

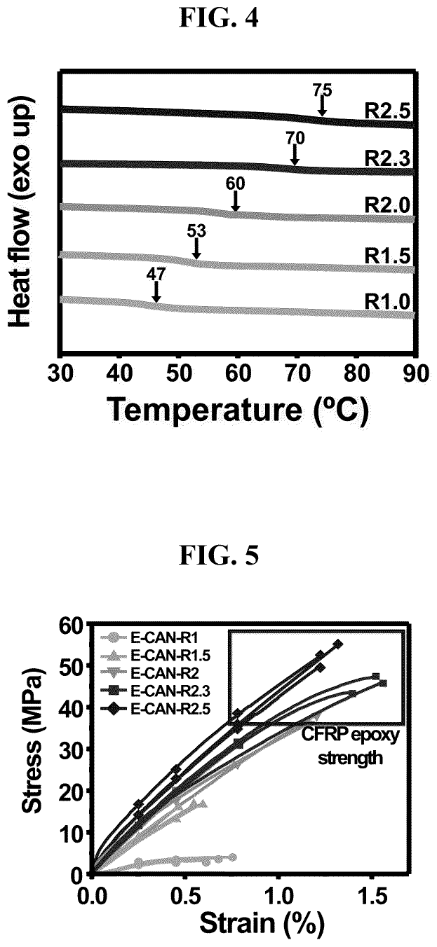

As the DGEBA content increases, the benzene ring content and the crosslinking density gradually increase. Since the high crosslinking density and benzene ring content impede the segmental motion of the polymer chains, it can be confirmed as shown in FIG. 4 that, as the DGEBA content increases, the chain mobility decreases and the T_{g} increases.

### <Experimental Example 4> Measurement of Mechanical Properties

In order to measure the mechanical properties of E-CAN, a 15×7×2 mm rectangular sample was subjected to tensile testing at a speed of 12.7 mm/min using a universal testing machine (UTM) to measure the elastic modulus and ultimate tensile strength (UTS) of the sample.

In order to compare the mechanical strength of E-CAN with that of a conventional epoxy material for CFRP, the tensile strength was measured using the UTM. For accurate strain measurement, E-CAN-R1.5 to E-CAN-R2.5 were installed on the extensometer. E-CAN-R1 was not installed on accurate strain measurement because it would bend when it was installed on the extensometer was installed.

Crosslinked polymers exhibit higher mechanical strength than thermoplastic polymers because of the formation of primary bonds between molecules. Furthermore, aromatic rings make the polymer stiffer. The elastic modulus was measured by the slope between 0.05% strain and 0.25% strain, which are within the elastic strain range of high-strength materials. UTS was defined as the stress value at which the E-CAN breaks.

As shown in FIG. 5, it could be confirmed that, as the DGEBA content increased, the elastic modulus and UTS gradually increased as the benzene ring content and the crosslinking density increased. The rapid increase in strength from R2 is predicted to be due to the rapid increase in crosslinking density caused by etherification. As shown in FIG. 5, the elastic modulus of the conventional epoxy material for composite materials was 2 to 6 GPa, and the UTS was 20 to 100 MPa. By controlling the content of the DGEBA monomer, it was confirmed that the materials from E-CAN-R2 to E-CAN-R2.5 were synthesized E-CANs having a physical strength similar to that of the conventional epoxy material for composite materials. Table 1 below shows the average values of the elastic moduli and UTS from three measurements in the tensile strength test of E-CANs.

TABLE 1

| | E-CAN- | E-CAN- | E-CAN- | E-CAN- | E-CAN- |
|---|---|---|---|---|---|
| | R1 | R1.5 | R2 | R2.3 | R2.5 |
| Avg. elastic | 0.82 | 3.42 | 4.17 | 4.57 | 5.16 |
| modulus (GPa) | | | | | |
| Avg. UTS | 3.71 | 16.7 | 37.2 | 45.6 | 52.3 |
| (MPa) | | | | | |

### <Experimental Example 5> Evaluation of Recyclability of E-CAN-R #

In order to evaluate the thermal recyclability and property recovery rate of E-CANs, a rectangular sample measuring 15×7×2 mm was reprocessed after being crushed three times, and then subjected to tensile testing at a speed of 12.7 mm/min using a universal testing machine (UTM) to measure the tensile strength of the sample. For crushing, each E-CAN was made into very fine particles using a freezer mill.

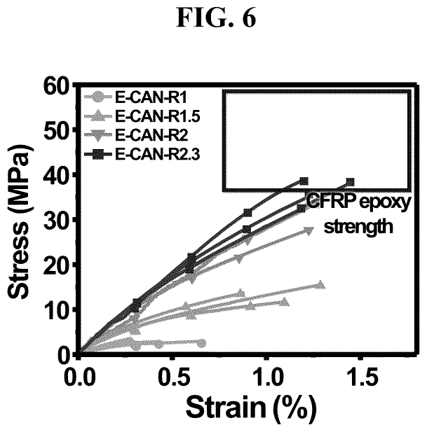

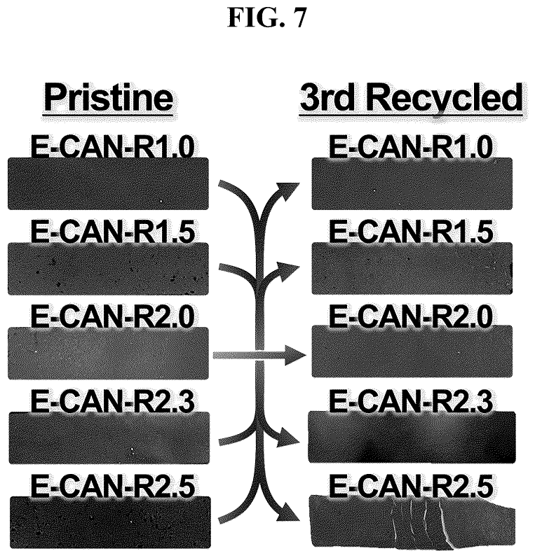

E-CAN-R1 and E-CAN-R1.5 were reprocessed through hot pressing under the conditions of 130° C., 20 MPa, and 3 hours, and E-CAN-R2 and E-CAN-R2.3 were reprocessed through hot pressing under the conditions of 160° C., 20 MPa, and 3 hours. As shown in FIG. 6, the samples reprocessed three times showed an elastic modulus and UTS of 80% of those of the conventional epoxy material. Table 2 below shows the average values of elastic moduli and UTS measured three times in the tensile strength tests for E-CANs recycled three times. Their mechanical strength, similar to that of the conventional epoxy material, and their ability to be recycled three times are significant advantages. The reason why the E-CANs showed a high property recovery rate even after being reprocessed multiple times is thought to be due to the introduction of two exchange reactions, which introduced relatively relaxed reprocessing conditions. Furthermore, the high thermal stability resulting from the stable structure due to aromatic rings and high crosslinking density is also thought to be the reason for the high property recovery rate in multiple recycles. As shown in FIG. 7, the E-CAN-R2.5 sample had a high proportion of permanent crosslinking as well as a low chain mobility due to increases in the benzene ring content and the crosslinking density, and thus it was partially reprocessed under temperature conditions of 160° C., 180° C., and 200° C., but full reprocessing thereof was not possible.

TABLE 2

| | E-CAN- | E-CAN- | E-CAN- | E-CAN- | E-CAN- |
|---|---|---|---|---|---|
| | R1 | R1.5 | R2 | R2.3 | R2.5 |
| Avg. elastic | 0.79 | 2.75 | 3.22 | 3.66 | x |
| modulus (GPa) | | | | | |
| Avg. UTS | 3.71 | 6.89 | 25.4 | 35.2 | x |
| (MPa) | | | | | |

### <Experimental Example 6> Evaluation of Thermal Stability of E-CAN-R #

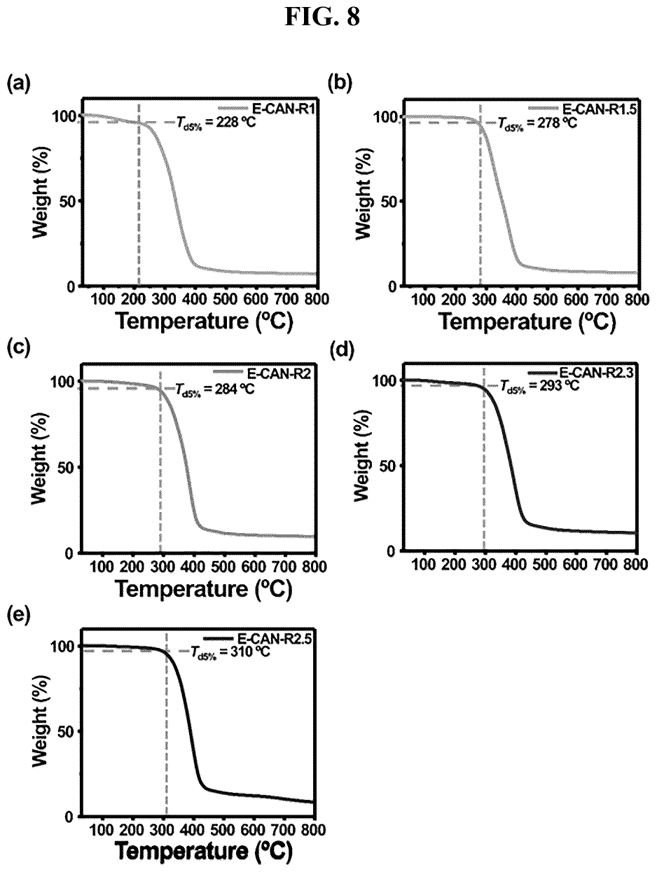

The thermal stability of E-CAN-R # was evaluated by performing measurement through thermogravimetric analysis (TGA) from 30° C. to 800° C. at a heating rate of 5° C./min. As a result, as shown in FIG. 8, above 200° C., all the samples showed T_{d5%} (the temperature at which mass loss reaches 5% in TGA) and began to undergo thermal decomposition.

The aromatic ring of DGEBA is thermally stable due to the rigidity of the molecular structure resulting from the resonance structure. Furthermore, thermosetting polymers have higher thermal stability than thermoplastic polymers, and are more stable against thermal decomposition due to the structural stability provided by the crosslinked structure and the bonds between molecules.

Similarly, it could be confirmed that the heat resistance gradually increased as the content of DGEBA, a polymer with high crosslinking density, increased. It is believed that, as the DGEBA content increases, the heat resistance is better because the proportion of permanent crosslinking increases compared to dynamic crosslinking, which is prone to thermal degradation. All subsequent experiments were conducted at temperatures below T_{d5%}, at which the samples do not decompose.

### <Experimental Example 7> Evaluation of Stress Relaxation Characteristics of E-CAN-R #

### DMA-Amplitude Sweep

To evaluate the stress relaxation characteristics of E-CAN-R #, a rectangular sample measuring 5 mm×1 mm×18 mm was measured using a dynamic mechanical analyzer (MCR 702e) at a strain of 0.1% and a frequency of 1 Hz while increasing the temperature from 0° C. to 200° C. at a of 3° C./min.

For stress relaxation measurement, one sample was subjected to a constant strain of 0.1% for 1,000 s while lowering the temperature by 10° C. from a high temperature.

When a strain is applied to a polymer sample, there is a strain region that can be somewhat restored when the force is removed due to entanglement. If a greater strain is applied, the sample cannot return to its original state because the molecular bonds are destroyed and deformation occurs. If a force sufficient to destroy molecular bonds is repeatedly applied, fatigue accumulates, causing the sample to deform and unreliable data. To prevent these problems, a DMA-amplitude sweep tests were performed to measure the linear viscoelastic region (LVR), which is the region where the sample cannot be elastically restored.

The measurement was performed in a log scale from 0.01% to 20% at 1 Hz, and the region before the point where E′ and E″ are in equilibrium and then begin to decrease is called LVR. The measurement results confirmed that all the samples formed LVR within 0.1% under 30° C. conditions in the DMA. Subsequent experiments were performed under conditions of 0.1% strain.

### DMA-Temperature Sweep

To evaluate the T_{g} and rubbery plateau characteristics, a rectangular sample measuring 5 mm×1 mm×18 mm was measured using a dynamic mechanical analyzer (MCR 702e) at a strain of 0.1% and a frequency of 1 Hz while increasing the temperature from 0° C. to 200° C. at a rate of 3° C./min.

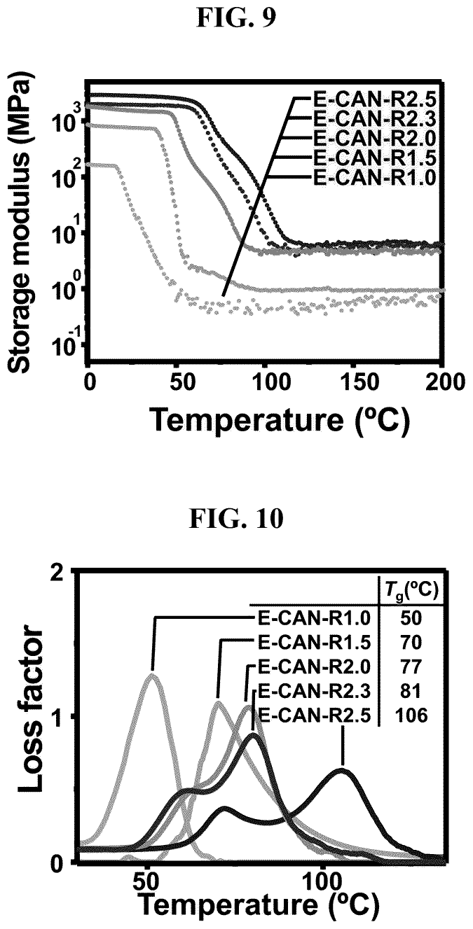

This is to determine T_{g} and the height of the rubbery plateau. The glass transition temperature is defined as the temperature at which the segmental motion of polymer chains begins. According to this definition, the most accurate method for measuring T_{g} is to directly observe the changes in E′ and E″ while actually applying strain to a polymer sample. Since crosslinked polymers do not exhibit complete flowability even at temperatures above T_{g}, E′, which represents the characteristics of a solid, continues to be maintained. The height at which this E′ is maintained is proportional to the crosslinking density of the polymer. This flat E′ is called the rubbery plateau. As shown in FIG. 9, it can be seen that, as the content of DGEBA increases, the crosslinking density increases, and thus the rubbery plateau gradually rises. T_{g} is defined as the peak where the stiff characteristic begins to become rubbery, with the loss factor E″/E′ having the largest value. As shown in FIG. 10, it could be confirmed that, as the content of DGEBA increased, T_{g} gradually increased, similar to the results of DSC. A shoulder peak occurred around 60 to 75° C., which is due to the homopolymerization of DGEBA itself. As the content of DGEBA increased, the temperature of the shoulder peak became closer to 75° C., the Tg of DGEBA, and became clearer. In addition, as the DGEBA content increased, the peak of the loss factor decreased. This is expected to be due to the low chain mobility and low heat dissipation capacity caused by the aromatic ring and high crosslinking density.

For reference, FIG. 9 shows the storage moduli of E-CANs measured through temperature sweep tests, wherein the elastic modulus was measured from 0° C. to 200° C. at a heating rate of 3° C./min at a frequency of 1 Hz and a strain of 0.1%. FIG. 10 shows the loss factors of E-CANs measured through temperature sweep tests, wherein loss factor=loss modulus/storage modulus. The loss factor was measured from 0° C. to 200° C. at a heating rate of 3° C./min at a frequency of 1 Hz and a strain of 0.1%. T_{g} is the center of the loss factor peak.

When an excessive amount of DGEBA is added, the crosslinking density is increased through etherification. Even when comparing the results of E′, it could be confirmed that the crosslinking density clearly increased. To confirm whether the actual increase in crosslinking density occurred, the density was measured and the molecular weight between crosslinks, M_{c}, was determined using the following equation.

The temperature substituted using the equation Mc=3ρRT/E was calculated by inputting the value at the storage modulus E′ (at Tg+50) at the temperature of the rubbery plateau region (T=T_{g}+50).

In fact, it can be seen that the molecular weight between crosslinks, M_{c}, significantly decreased from E-CAN-R2, the point at which the physical properties significantly increased as the DGEBA content increased, indicating that the crosslinking density significantly increased and that the crosslinking density had a significant effect on the tensile strength. Table 3 below shows the molecular weight between crosslinks (Mc) obtained using the equation Mc=3ρRT/E′.

TABLE 3

| | ρ (g/cm³) | T_{g} | E′ | Mc |
|---|---|---|---|---|
| | at 22° C. | (° C.) | (MPa) | (g/mol) |
| E-CAN-R1 | 1.25 | 34 | 0.44676 | 24924 |
| E-CAN-R1.5 | 1.247 | 70 | 0.94212 | 12979 |
| E-CAN-R2 | 1.242 | 77 | 3.0434 | 4073 |
| E-CAN-R2.3 | 1.238 | 93 | 4.07 | 3157 |
| E-CAN-R2.5 | 1.23 | 106 | 6.4098 | 2054 |

### Confirmation of DMA-Stress Relaxation

Thermosetting polymers exhibit very little stress relaxation due to their cross-linked structure. However, E-CAN-R #, which undergoes disulfide metathesis and transesterification reactions, may have flowability and thus exhibit stress relaxation behavior, similar to thermoplastic polymers. Stress relaxation is a phenomenon in which, when a certain strain is applied to a polymer, the stress applied to the polymer decreases over time due to the flow of molecular chains. When stress relaxation occurs, there is a time period in which the measured stress becomes 1/e of the initial stress, and this period is defined as the relaxation time. In a relatively low-temperature region, the Williams-Landel-Ferry (WLF) equation, which follows segmental motion based on free volume theory, is usually applied. In a high-temperature region, chemical reactions, i.e., exchange reactions, occur, and this behavior is described by the Arrhenius equation. Since both equations have a relaxation-time term depending on temperature, the relaxation time was obtained through stress relaxation progress for each temperature. After plotting each temperature and relaxation time on the x-axis and y-axis, based on the region where the trend changed, fitting to the WLF equation was done for the relatively low-temperature region and fitting to the Arrhenius equation was done for the high-temperature region. The reason why the behavior of polymers following the Arrhenius equation appears after a certain temperature is because exchange reactions begin to become dominantly activated. The point where the two equations intersect as determined as the topology freezing transition temperature (Tᵥ). The temperature conditions for the above-described UTM reprocessing were determined as Tᵥ obtained from rheological properties. Since the exchange reactions become dominant at temperatures above Tᵥ, reprocessing was possible at temperatures above Tᵥ. The reason why reprocessing becomes increasingly difficult due to the high benzene ring content and crosslinking density could be confirmed through the increase in the topology freezing transition temperature, Tᵥ. Activation energy is a term of the Arrhenius equation and is represented by the slope of the graph. This can be interpreted as the degree to which relaxation time changes with temperature. Since the relaxation time depends on exchange reactions, having a high activation energy means that the rate at which the exchange reactions are activated is greater even with a small change in temperature.

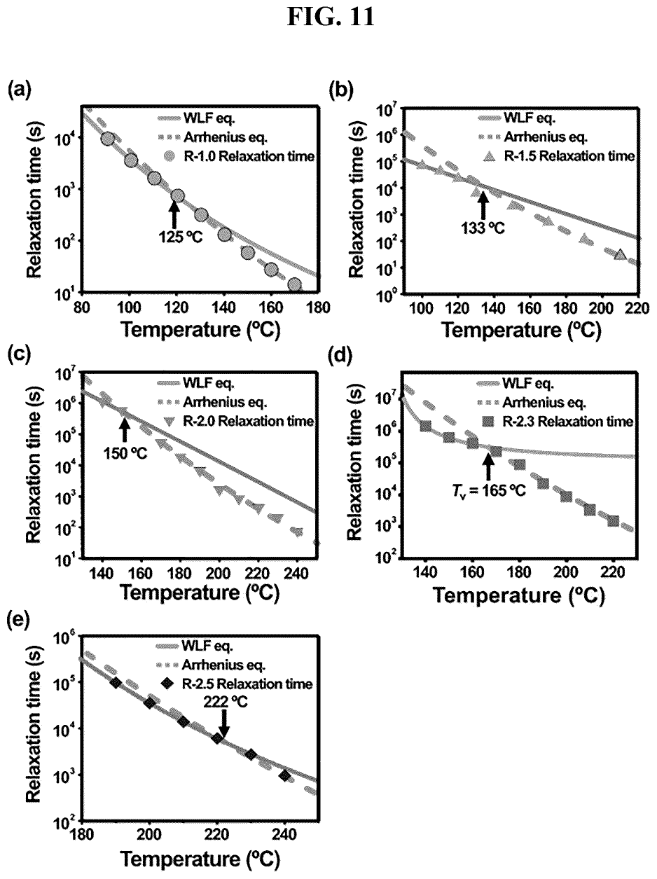

As shown in FIG. 11, as the DGEBA content increases, Tᵥ and activation energy tend to increase. Before and after Tᵥ, the WLF equation and Arrhenius equation are dominant, but they are not 100% completely dominant. The behaviors before and after Tᵥ influence each other, and the ratio between the two behaviors gradually changes depending on the temperature. E-CAN, which has extremely low chain mobility due to its high crosslinking density and benzene ring content, has a high Eₐ in the WLF equation, which is interpreted as an effect that increases the activation energy in the region where the exchange reactions are dominant. The difference in activation energy of E-CAN-R1.5 and E-CAN-R2, where the content of DGEBA is 1.5 to 2 times, is very large, and this is also the region where a rapid increase in tensile strength and crosslinking molecular weight (M_{c}) appears. In the case of R2.5, as shown in FIG. 11e, fitting to the WLF equation rather than fitting to the Arrhenius equation is largely followed, and thus it can be interpreted that exchange reactions hardly occur and the reprocessability is very low.

For reference, FIG. 11 shows the results of fitting E-CANs to the WLF equation and the Arrhenius equation using the stress relaxation time measured as a function of temperature.

Table 4 below summarizes the overall physical properties of E-CANs measured above.

TABLE 4

| | E-CAN- | E-CAN- | E-CAN- | E-CAN- | E-CAN- |
|---|---|---|---|---|---|
| | R1 | R1.5 | R2 | R2.3 | R2.5 |
| T_{g} (DSC) | 47 | 53 | 60 | 70 | 75 |
| T_{g} (DMA) | 34 | 70 | 77 | 93 | 106 |
| Avg. elastic | 0.82 | 3.42 | 4.17 | 4.57 | 5.16 |
| modulus (GPa) | | | | | |
| Avg. UTS (MPa) | 3.71 | 16.7 | 37.2 | 45.6 | 52.3 |
| Avg. elastic | 0.79 | 2.75 | 3.22 | 3.66 | x |
| modulus | | | | | |
| (GPa)_Recycled | | | | | |
| Avg. UTS | 3.71 | 6.89 | 25.4 | 35.2 | x |
| (MPa)_Recycled | | | | | |
| T_{d5%} (° C.) | 228 | 278 | 284 | 293 | 310 |
| Mc (g/mol) | 24924 | 12979 | 4073 | 3157 | 2054 |
| Tv (° C.) | 125 | 133 | 150 | 165 | 222 |
| Ea (kJ/mol) | 118 | 120 | 172 | 178 | 198 |

### <Experimental Example 8> Chemical Decomposition and Recycling

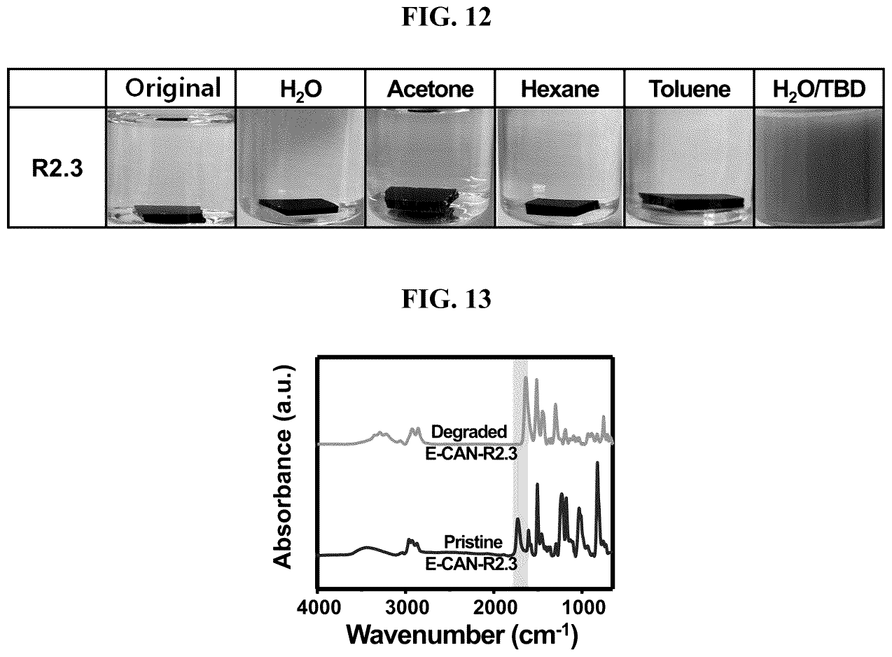

As shown in FIG. 12, chemical decomposition of E-CAN-R2.3 was performed using various solvents on a hot plate at 160° C. for 24 hours. Transesterification in E-CAN occurred at a high temperature of 160° C. or higher under TBD conditions. Reaction Scheme 3 below shows the decomposition mechanism in H₂O/TBD under high-temperature and 1 M H₂O/ITBD conditions. As shown therein, the ester group in E-CAN and the —OH group of the low-molecular-weight H₂O undergo transesterification, causing the molecular chain to be gradually broken and decomposed. As a result, as shown in FIG. 13, it could be confirmed through FT-IR that a carboxylic acid group was formed. If the water in the decomposed E-CAN is evaporated, it can be reused as a raw material.

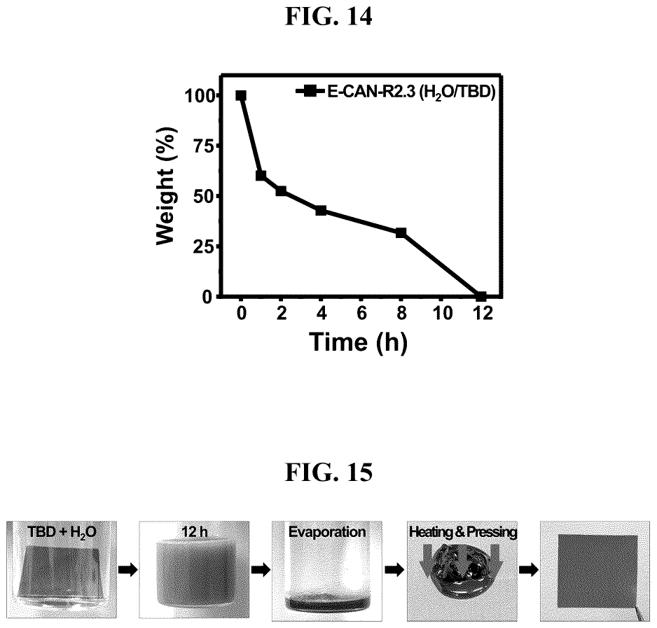

It is expected that high-temperature H₂O would easily penetrate into E-CAN containing a large number of hydrophilic functional groups, such as —OH groups and ester groups. As shown in FIG. 14, it was confirmed that the penetrated TBD and H₂O completely decomposed the E-CAN within 12 hours. For reference, FIG. 14 shows the weight percentage of chemical decomposition in H₂O/TBD at 160° C. for 12 hours.

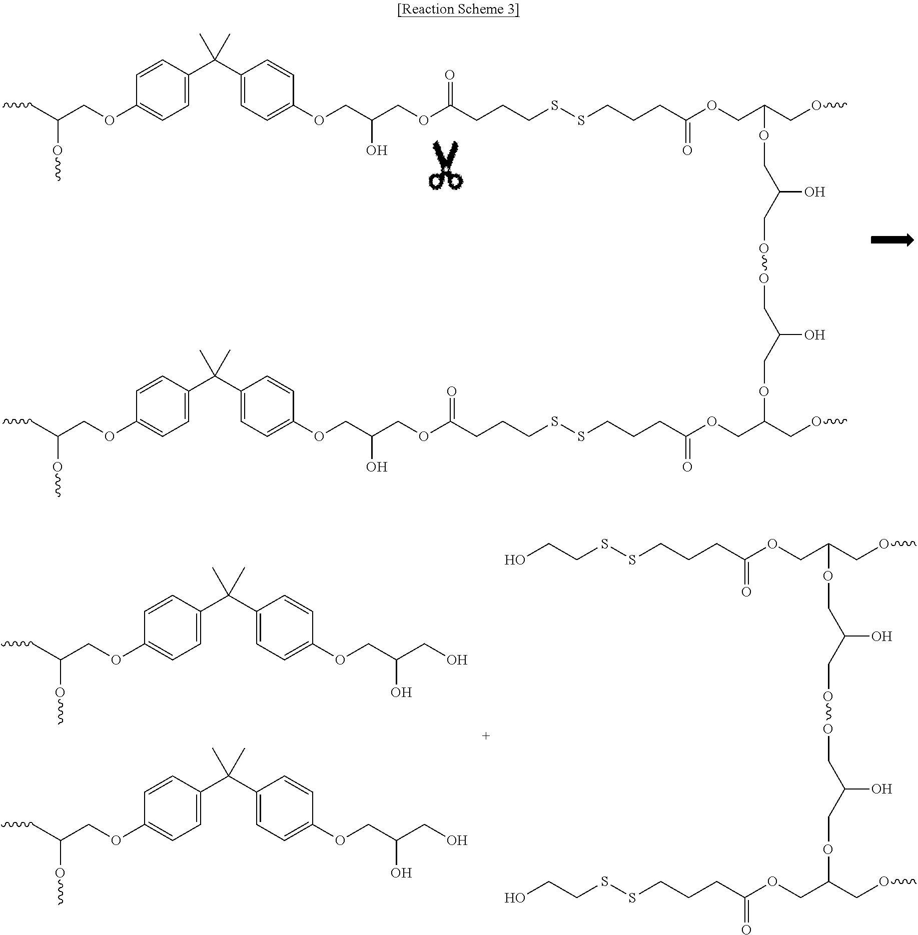

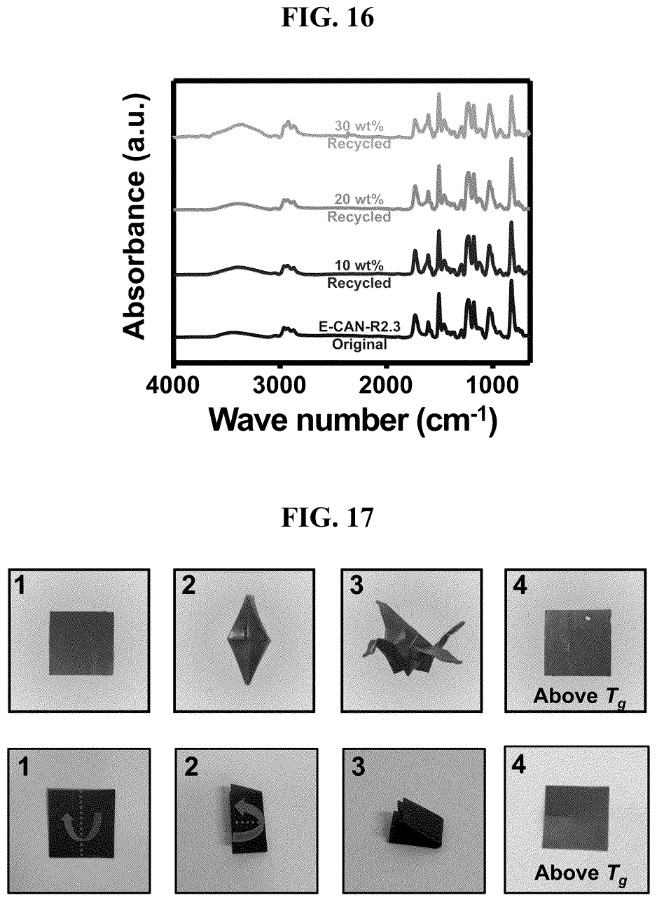

For conventional CAN materials, organic solvents that can be toxic to the human body or the environment were mainly used. However, as shown in FIG. 15, eco-friendly water was used as a solvent, and E-CAN was decomposed through a simple process by adding TBD as a catalyst, followed by boiling. The E-CAN may be reused as a raw material simply by evaporating water therefrom without any additional purification or recovery process. In addition, even E-CAN-R2.5, which is difficult to recycle due to its low reprocessability, can be recycled through chemical decomposition. As shown in FIG. 16, the decomposed E-CAN was recycled by adding it in an amount of 10 wt %, 20 wt %, or 30 wt % to the original E-CAN monomer. Almost similar conditions and FT-IR peaks could be confirmed. The E-CAN-R1 to E-CAN-R2.3 materials will also be able to fully recover their properties by returning to the initial monomers, even when their properties deteriorated due to multiple reprocessing.

For reference, FIG. 15 is photographs showing the process of recycling E-CAN-R2.3 without an additional purification process. The recycling process was the same as before, and the same curing conditions of 180° C. for 4 hours were used. FIG. 16 shows the results of measuring FT-IR peak depending on the weight percentage of E-CAN-R2.3 recycled without an additional purification process after chemical decomposition in H₂O/TBD at 160° C. for 12 hours.

As confirmed through the above Examples, the E-CAN according to the present disclosure was synthesized by forming ester and hydroxyl groups through the reaction between epoxy rings and a carboxylic acid to allow transesterification, and inducing disulfide metathesis reaction through a disulfide bond within DTDA to introduce dual dynamic networks. By doing so, relaxed reprocessing conditions were obtained.

As a result of controlling the ratio between dynamic and permanent crosslinking and crosslinking density by controlling the DGEBA content, from E-CAN-R2 in which the proportion of permanent crosslinking and crosslinking density began to increase rapidly, mechanical strength similar to the strength of the conventional epoxy resin was exhibited. However, it was confirmed that complete reprocessing was not possible from the E-CAN-R2.5 ratio in which chain mobility significantly decreased. The monomer used together is DTDA, which has a disulfide group and carboxylic acid terminals.

Epoxy materials having the advantage of high strength have low chain mobility, and thus the reprocessing conditions therefor can be relaxed by introducing two exchange reactions. As the content of DGEBA increased, the mechanical properties were gradually improved by inducing a high benzene ring content and high crosslinking density. At a ratio of E-CAN-R2.3, E-CAN could be produced, which had mechanical strength similar to that of conventional epoxy resin while having a property recovery rate of more than 80% even after being reprocessed three times.

Measurements of rheological properties showed that Tᵥ and activation energy increased with increasing DGEBA content. This is believed to be because chain mobility decreased. The benzene ring and high crosslinking density hinder exchange reactions of dynamic bonds, making reprocessing difficult. Therefore, E-CAN-R2.5 was difficult to reprocess, making UTM measurements impossible.

It was confirmed that E-CAN whose properties had deteriorated after being reprocessed multiple times was completely decomposed within 12 hours under high-temperature H₂O/TBD conditions. Decomposition occurred through an exchange reaction with the —OH groups of high-temperature water in the presence of TBD, an exchange reaction catalyst. A portion of the decomposed E-CAN could be recycled into a sample with nearly identical FT-IR peaks by mixing it with the original monomer.

### <Experimental Example 9> Shape Memory and Reconfigurability

As shown in Table 1 above, E-CAN-R2.3 exhibited a high elastic modulus of 4.57 GPa even at room temperature. Based on this high elastic modulus, E-CAN-R2.3 exhibits high elasticity even at temperatures above T_{g} at which the sample begins to soften. Based on this high mechanical strength, the E-CAN film has a shape memory property that allows it to return to its original state without any trace of folding when placed at a temperature above T_{g} after folding.

After forming a shape at a temperature above Tᵥ, the shape is fixed by relieving the stress applied to the folded part. In addition, since exchange reactions occur at a temperature above Tᵥ, shape fixing is performed at a temperature above Tᵥ. Since the stress relaxation time is very long at Tᵥ, shape fixing was performed at a temperature of 240° C., at which the stress relaxation time is short.

As shown in FIG. 17, regarding the shape memory property, it was confirmed that the E-CAN film returned to its original state without significant damage even after being folded into a complex shape such as a crane shape.

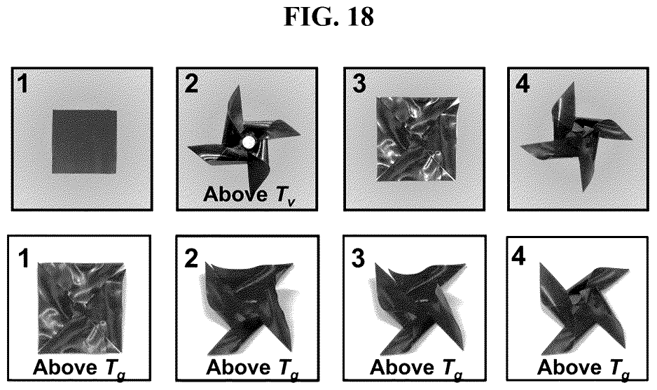

In addition, as shown in FIG. 18, the E-CAN sample exhibited shape reconfigurability by causing stress relaxation at a temperature above Tᵥ at which exchange reactions occur after fixing the shape due to its dynamic bonds. After fixing E-CAN-R2.3 in a pinwheel shape and then stretching it again, E-CAN-R2.3 returned to a pinwheel shape again when placed above T_{g}, suggesting that E-CAN-R2.3 exhibited shape reconfigurability.

Therefore, the present disclosure has a differentiated characteristic compared to conventional thermosetting polymer epoxy materials because the conventional epoxy materials have only permanent crosslinking and thus stress relaxation through exchange reactions is impossible, making shape fixing impossible.

Although the fully recyclable, dual dynamic bond-based high-strength epoxy polymer and the method for producing the same according to the preferred embodiment of the present disclosure have been described in detail above, this description is merely an example, and it will be well understood by those skilled in the art that various changes and modifications are possible without departing from the technical spirit of the present disclosure.

1. A fully recyclable high-strength epoxy polymer comprising:
a first monomer containing two or more epoxy groups;
a second monomer comprising a sulfur-containing aliphatic carboxylic acid; and
a third monomer acting as a catalyst,
the epoxy polymer being synthesized through dual dynamic reactions using the third monomer that facilitates a reaction between the epoxy groups of the first monomer and both ends of the aliphatic carboxylic acid of the second monomer.

2. The fully recyclable high-strength epoxy polymer of claim 1, wherein the dual dynamic reactions include transesterification and disulfide metathesis reactions.

3. The fully recyclable high-strength epoxy polymer of claim 1, wherein the first monomer comprises any one or more selected from the group consisting of bisphenol-based epoxy resin, aminophenol-based epoxy resin, siloxane-based epoxy resin, and alicyclic epoxy resin.

4. The fully recyclable high-strength epoxy polymer of claim 1, wherein the second monomer is any one selected from the group consisting of 2.2′-dithiobenzoic acid, 3.3′-dithiopropionic acid, 4,4′-dithiodibutyric acid, 5,5′-dithiobis(2-nitrobenzoic acid), 6,6′-dithiodinicotinic acid, DL-homocystine, penicillamine disulfide, and L-glutathione oxidized.

5. The fully recyclable high-strength epoxy polymer of claim 1, wherein the third monomer is 1,5,7-triazabicyclo[4.4.0]dec-5-ene (TBD).

6. The fully recyclable high-strength epoxy polymer of claim 1, wherein the epoxy polymer comprises the first monomer (DGEBA) and the third monomer (TBD) at a molar ratio of 1 to 2.5:0.02 to 0.04 moles per mole of the second monomer (DTDA).

7. The fully recyclable high-strength epoxy polymer of claim 1, wherein the epoxy polymer is decomposable and recyclable when immersed and heated in an aqueous solution of 1,5,7-triazabicyclo[4.4.0]dec-5-ene (TBD).

8. The fully recyclable high-strength epoxy polymer of claim 1, wherein the epoxy polymer has a shape memory property that allows it to return to its original shape at a temperature above a glass transition temperature (T_{g}) thereof.

9. A method for producing a fully recyclable high-strength epoxy polymer, comprising:
a step of preparing a transparent solution by mixing and heating a first monomer and a second monomer;
a step of preparing a mixture by adding a third monomer to the transparent solution, followed by stirring;
a step of pre-curing the mixture by heating after pouring the mixture into a mold; and
a main curing step of curing the pre-cured mixture by heating in a vacuum.

10. The method of claim 9, wherein the step of preparing the transparent solution comprises mixing the first monomer (DGEBA) and the second monomer (DTDA) at a molar ratio of 1 to 2.5:1, and the step of preparing the mixture comprises adding the third monomer (TBD) in an amount of 0.02 to 0.04 moles per mole of the second monomer (DTDA).

11. The method of claim 9, wherein the first monomer comprise any one or more selected from the group consisting of bisphenol-based epoxy resin, aminophenol-based epoxy resin, siloxane-based epoxy resin, and alicyclic epoxy resin.

12. The method of claim 9, wherein the second monomer is any one selected from the group consisting of 2.2′-dithiobenzoic acid, 3.3′-dithiopropionic acid, 4,4′-dithiodibutyric acid, 5,5′-dithiobis(2-nitrobenzoic acid), 6,6′-dithiodinicotinic acid, DL-homocystine, penicillamine disulfide, and L-glutathione oxidized.

13. The method of claim 9, wherein the third monomer is 1,5,7-triazabicyclo[4.4.0]dec-5-ene (TBD).

14. The method of claim 9, wherein the step of preparing the transparent solution comprises heating to a temperature of 170 to 190° C.

15. The method of claim 9, wherein the step of pre-curing comprises curing by heating at a temperature of 170 to 190° C. for 45 to 75 minutes.

16. The method of claim 9, wherein the main curing step comprises curing by heating at a temperature of 170 to 190° C. for 3 to 10 hours at a vacuum pump pressure of 0 to 0.1 MPa.
